(19) United States
(12) Patent Application Publication
(10) Pub. No.: US 2017/0211706 A1
(43) Pub. Date: Jul. 27, 2017

(54) CERAMIC SLIT VALVE DOORS AND ASSEMBLIES

(71) Applicant: Applied Materials, Inc., Santa Clara, CA (US)

(72) Inventors: Ofer Amir, Half Moon Bay, CA (US); Michael R. Rice, Pleasanton, CA (US); Jennifer Y. Sun, Mountain View, CA (US); Michael C. Kuchar, Georgetown, TX (US)

(21) Appl. No.: 15/407,651

(22) Filed: Jan. 17, 2017

Related U.S. Application Data
(60) Provisional application No. 62/287,797, filed on Jan. 27, 2016.

(51) Int. Cl. F16K 3/02

(52) U.S. Cl. CPC F16K 3/0263; F16K 3/0227

(57) ABSTRACT

Slit valve doors including a door body made entirely of an Al₂O₃ ceramic material, and a seal coupled to the door body. Slit valve door assemblies and slit valve assemblies including the slit valve door are disclosed, as are numerous other aspects.

### RELATED APPLICATION

The present application claims priority to U.S. Provisional Application Ser. No. 62/287,797 filed Jan. 27, 2016, and entitled “CERAMIC SLIT VALVE DOOR AND ASSEMBLIES” (Attorney Docket No. 23401/USA/L), which is hereby incorporated by reference in its entirety herein for all purposes.

### FIELD

The present invention relates to electronic device manufacturing, and more specifically to slit valve doors and slit valve assemblies including slit valve doors.

### BACKGROUND

Conventional electronic device manufacturing apparatus may include process chambers and/or one or more load lock chambers. Each of the chambers may be included in a cluster tool where the chambers may be distributed about a transfer chamber, for example. These tools may employ a multi-arm transfer robot that may be housed within the transfer chamber and may operate to transport substrates between the various process chambers and one or more load lock chambers.

Conventionally, a slit valve assembly is provided at the entries to the process chambers and also at the entries into the one or more load lock chambers. Generally, one slit valve assembly is provided for each entry. The load lock chambers may include more than one entry as they are generally designed for pass through to the transfer chamber in one direction and pass through to a factory interface chamber in another direction. Thus, the load lock chambers may include two slit valve assemblies. An end effector (e.g., blade) of the transfer robot is configured to pass through a slit of each of the slit valve assemblies in order to place or extract a substrate (e.g., silicon wafer or other silicon-containing member) therein. Substrate may be an electronic device precursor. Each slit valve assembly may open to allow end effector access and may then close in order to seal the respective chambers once the substrate has been inserted therein.

However, conventional slit valve assemblies are made from aluminum. Such conventional slit valve assemblies may suffer from problems that may affect the quality of the processes taking place in the chamber.

Accordingly, improved slit valve assemblies and slit valve doors are desired.

### SUMMARY

In one aspect, a slit valve door is provided. The slit valve door includes a door body made entirely of an Al₂O₃ ceramic material, and a seal coupled to the door body.

In another aspect, a slit valve door assembly is provided. The slit valve assembly includes a backing plate, a slit valve door coupled to the backing plate, the slit valve door including a door body made entirely of an Al₂O₃ ceramic material, and a seal coupled to the door body. The backing plate substantially supports the rear face of the door body.

In another aspect, a slit valve assembly is provided. The slit valve assembly includes a sealing insert including a slit opening and a sealing surface, a slit valve door assembly configured to seal against the sealing surface, the slit valve door assembly including a backing plate, and a slit valve door coupled to the backing plate, the slit valve door including a door body made entirely of an Al₂O₃ ceramic material, and a seal coupled to the door body.

Numerous other features are provided in accordance with these and other aspects of the invention. Other features and aspects of the present invention will become more fully apparent from the following detailed description, the appended claims and the accompanying drawings.

### BRIEF DESCRIPTION OF THE DRAWINGS

FIG. 1 illustrates a schematic top view of a substrate processing apparatus including a robot apparatus located in a transfer chamber and adapted to transport substrates through one or more inventive slit valve assemblies according to one or more embodiments.

FIG. 2A illustrates a partially cross-sectioned side view of an embodiment of a slit valve assembly shown in a closed and sealed orientation according to one or more embodiments.

FIG. 2B illustrates a partially cross-sectioned side view of an embodiment of a slit valve assembly shown in an opened and retracted orientation according to one or more embodiments.

FIG. 2C illustrates an isometric view of an embodiment of slit valve door assembly according to one or more embodiments.

FIG. 3A illustrates a front isometric view of a slit valve door assembly with an actuation rod removed according to one or more embodiments.

FIG. 3B illustrates a top plan view of a slit valve door assembly with the actuation rod removed according to one or more embodiments.

FIG. 3C illustrates a back plan view of a slit valve door assembly with the actuation rod removed according to one or more embodiments.

FIG. 4A illustrates a front plan view of a slit valve door including O-ring groove according to one or more embodiments.

FIG. 4B illustrates a side plan view of a slit valve door according to one or more embodiments.

FIG. 4C illustrates an end plan view of a slit valve door illustrating the cutting tool access according to one or more embodiments.

FIG. 4D illustrates an enlarged, partial cross-sectioned side view of an O-ring groove of a slit valve door according to one or more embodiments.

### DETAILED DESCRIPTION

Electronic device manufacturing may use slit valve assemblies to allow sealing of a slit passage between various chambers in order to isolate environments and/or to provide a vacuum in one chamber or differential vacuum between the respective chambers. Prior art slit valve assemblies may include anodized aluminum slit valve doors, which are porous and may crack and/or abrade over time and thus produce unwanted particulates. These particulates may adhere to the substrates being processed and thereby may cause quality problems that may affect yield. To solve this problem, the present invention provides an improved slit valve assembly including an improved slit valve door assembly and slot valve door.

In one aspect, an improved slit valve door is provided that includes a door body made entirely of an Al₂O₃ ceramic material, and a seal coupled to the door body. The Al₂O₃ ceramic material may have a relatively high bulk density, and may be substantially free of surface pores. The Al₂O₃ ceramic material has a relatively high bending strength at room temperature, and may have a relatively high Young's modulus.

In another aspect, a slit valve assembly is provided. The slit valve assembly includes a sealing insert adapted to be received in a housing, the sealing insert including a slit opening and a sealing surface, and a slit value door assembly configured to seal against the sealing surface. The slit valve door assembly includes a backing plate, and the slit valve door coupled to the backing plate, such as by bonding.

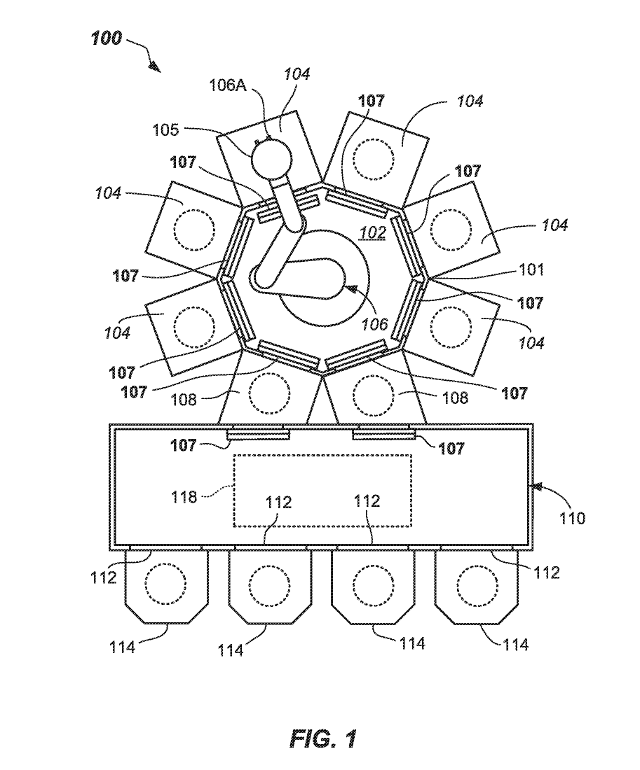

Further details of example embodiments of various aspects of the invention, including embodiment of the slit valve door, slit valve door assemblies including the slit valve door, and slit valve assemblies are described with reference to FIGS. 1-4D herein.

FIG. 1 illustrates a top view schematic diagram of an electronic device processing apparatus 100 according to one or more embodiments of the present invention. The electronic device processing apparatus 100 may be adapted to process substrates (e.g., 300 mm or 450 mm silicon-containing wafers, silicon plates, or the like) by imparting one or more processes thereto, such as degassing, cleaning or pre-cleaning, deposition such as chemical vapor deposition (CVD), physical vapor deposition (PVD), or atomic layer deposition, coating, oxidation, nitration, etching, polishing, lithography, or the like.

The depicted electronic device processing apparatus 100 may include a housing 101 including a transfer chamber 102 formed therein. The transfer chamber 102 may be formed by a lid (removed for illustration purposes), and bottom and side walls and may be maintained at a vacuum in some embodiments, for example. Housing may include any suitable shape, such as square, rectangular, pentagon, hexagon, heptagon, octagon (as shown), or other geometric shapes. In the depicted embodiment, a robot 106, such as a multi-arm robot may be received at least partially inside of the transfer chamber 102 and is adapted to be operable therein to service various chambers (e.g., one or more process chambers 104 and/or one or more load lock chambers 108) arranged around the transfer chamber 102. “Service” as used herein means to place or pick a substrate 105 into or out of a chamber (e.g., a process chamber 104 and/or a load lock chamber 108) with an end effector 106A of the robot 106. Six process chambers 104 are shown and two load lock chambers 108. However, other numbers of process chambers 104 and load lock chambers 108 may be used.

The robot 106 may be adapted to pick or place substrates 105 (sometimes referred to as a “wafer” or “semiconductor wafer”) mounted on the end effector 106A (sometimes referred to as a “blade”) of the robot 106 to or from a destination through one or more of the inventive slit valve assemblies 107. In the depicted embodiment, all of the slit valve assemblies 107 include the inventive features described herein. However, less than all of the slit valve assemblies 107 may be inventive, i.e., some may be conventional.

In the depicted embodiment of FIG. 1, the robot 106 may be any suitable multi-arm robot that has sufficient mobility to transfer a substrate 105 between the various process chambers 104 and/or load lock chambers 108. The load lock chambers 108 may be adapted to interface with a factory interface 110 that may receive substrates 105 from substrate carriers 114, such as Front Opening Unified Pods (FOUPs) docked at load ports 112. A load/unload robot 118 (shown dotted) may be used to transfer substrates 105 between the substrate carriers 114 and the load lock chambers 108. Transfers may be carried out in any sequence or order. The inventive slit valve assembly 107 may be provided at some or all of the entrances into every process chamber 104 and also at some or all of the entrances of the load lock chambers 108.

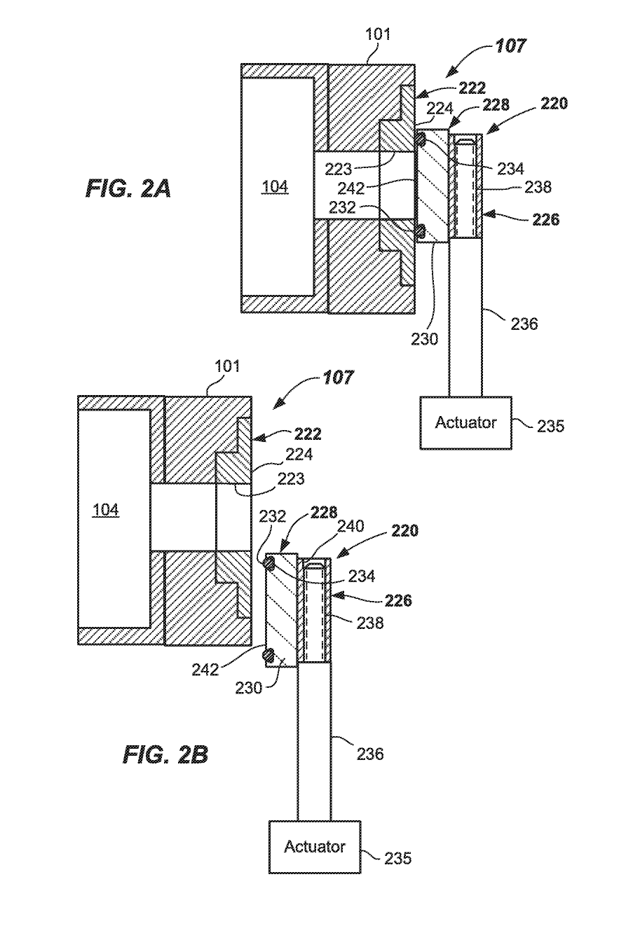

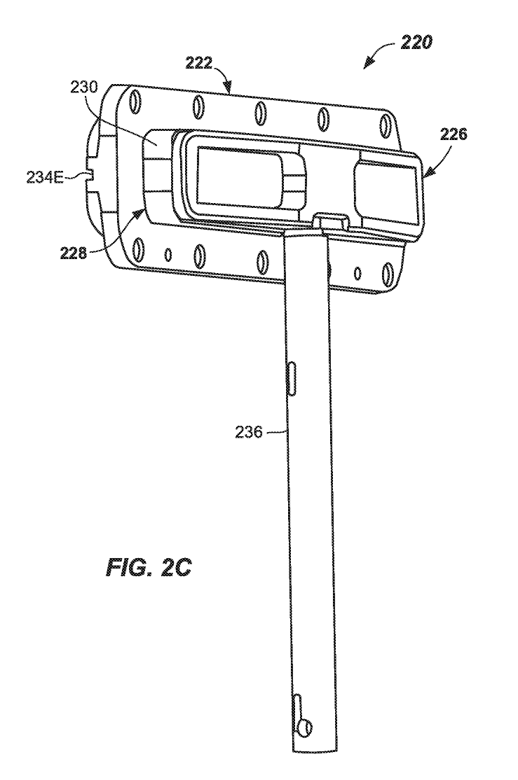

Now referring in more detail to FIGS. 2A-2C, one or more embodiments of a slit valve assembly 107 and slit valve door assembly 220 are described in detail. The slit valve assembly 107 includes a sealing insert 222 including a slit opening 223 and a sealing surface 224 surrounding the slit valve opening. The slit opening 223 is sized sufficiently to receive the substrate 105 and the end effector 106A therein. The slit opening 223 generally has a size wide enough to accommodate the substrate 105. For example, the width may be large enough to accommodate a 300 mm or 450 mm diameter wafer. The height of the slit opening 223 may be very small in comparison to the width, and generally just large enough to accommodate the substrate 105 and end effector 106A and any vertical pick and place moves. The sealing insert 222 may be coupled to the housing 101 in the case of a slit valve assembly 107 associated with a process chamber 104, or to the body forming the load lock chamber 108 in the case of a slit valve assembly 107 associated with a load lock chamber 108. In the depicted embodiment, the sealing insert 222 is shown coupled to the housing 101, such as by fasteners and suitable sealing, and the slit opening 223 leads to a process chamber 104.

As shown, the slit valve door assembly 220 is configured and adapted to seal against the sealing surface 224. The sealing surface 224 may be a smooth and planar surface, for example. In the depicted embodiment, the slit valve door assembly 220 includes a backing plate 226 and a slit valve door 228 coupled to the backing plate 226. The coupling may be by bonding in one or more embodiments. The slit valve door 228 may include, in one configuration, a door body 230 made entirely of an Al₂O₃ ceramic material, and a seal 232 coupled to the door body 230. The backing plate 226 may comprise an aluminum material.

The door body 230 may include a height and width sufficient to adequately cover the slit opening and allow sealing thereabout. In one embodiment, the door body 230 may include a height of between about 20 mm and 75 mm, a width of between about 310 mm and 500 mm, and a thickness of between about 10 mm and 50 mm. Other suitable sizes may be used.

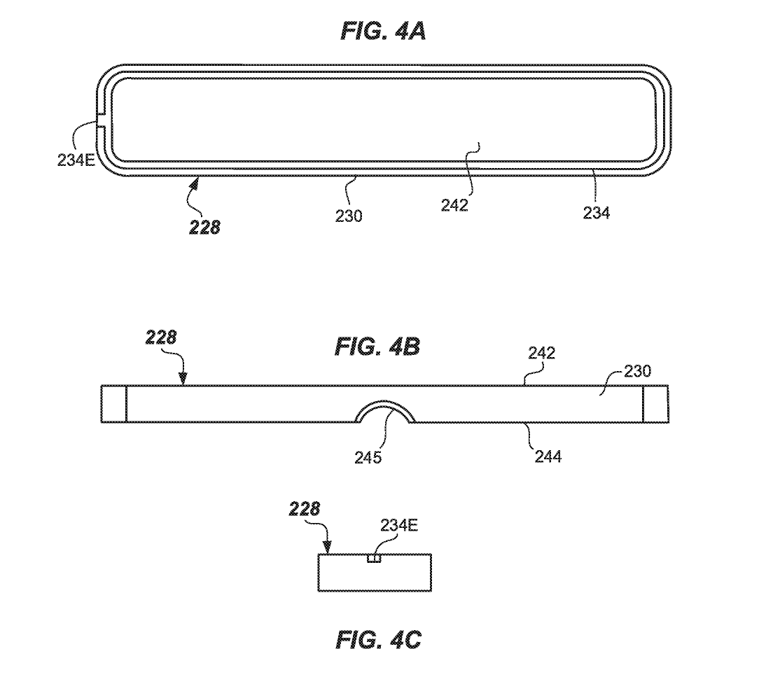

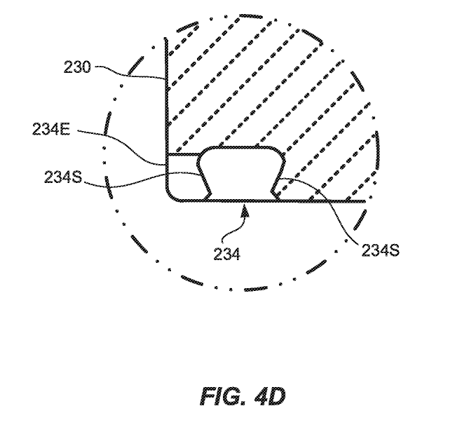

The seal 232 may be an O-ring seal that is received in an O-ring groove 234 that has been formed by machining (e.g., grinding) into a front face 242 of the door body 230 of the slit valve door 228. Seal 232 may be made of any suitable material for the temperature experienced in use, such as a fluorocarbon elastomer such as VITON® available from Dupont Performance Elastomers, a perfluoroelastomer such as KALREZ® available from Dupont Performance Elastomers, or a perfluoroelastomer such as CHEMTRAZ® available from Fibre Glass-Evercoat Company, Inc., or the like. O-ring groove 234 may include a tool access entry 234E located at an end of the slit valve door 228. The tool access entry 234E allows the cutting tool to enter from the side and then proceed to cut the shape of the O-ring groove 234 as shown in FIGS. 4A and 4D. As shown in FIG. 4D, the O-ring groove 234 may include groove sides 234S that angle away from one another into the thickness dimension of the door body 230 and form a pocket feature adapted to secure the seal 232 therein.

In operation, movement of the slit valve door assembly 220 is accomplished by actuation of an actuator 235 coupled to an actuation rod 236 of the slit valve door assembly 220. The actuation rod 236 may coupled to the backing plate 226 as shown, such as by receiving and securing a threaded end 238 into a like threaded hole 240 formed in the backing plate 226. Other means for connection of the actuation rod 236 to the backing plate 226 may be used. Motion of the slit valve door assembly 220 may be L-motion caused by the actuator 235 in some embodiments. Other suitable motions may be carried out to move the slit valve door assembly 220 away from the sealing surface 224 and retract the slit valve door assembly 220 to a position sufficiently below the slit opening 223 so that the process chamber 104 may be serviced. Like motions may be undertaken in reverse to close and seal the slit valve door 228 to the sealing surface 224.

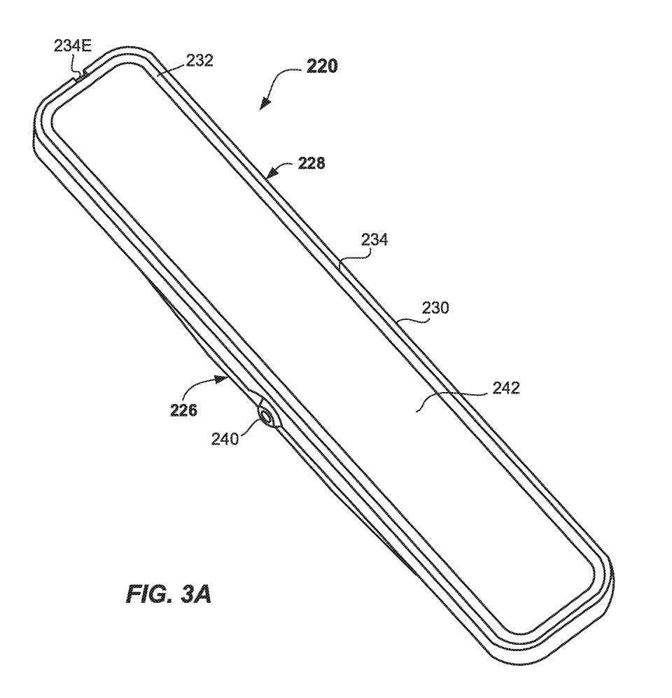

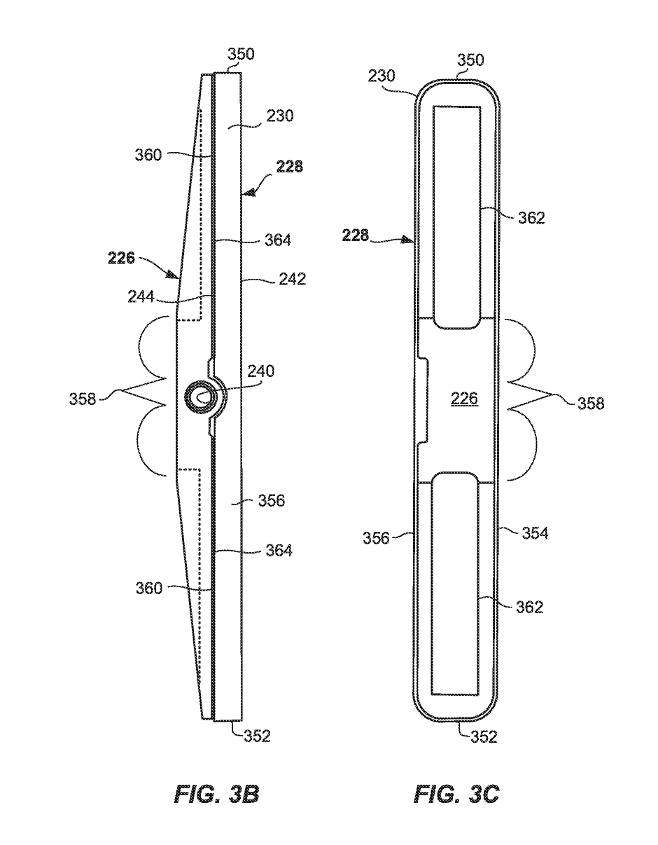

As best shown in FIGS. 3A-4D, embodiments of the slit valve door assembly 220 and the slit valve door 228 are shown. The door body 230 of the slit valve door 228 includes the front face 242 that may be planar and a rear face 244 that may be planar, and also parallel to each other. The slit valve door 228 may include a recess 245 formed on the rear face 244. The recess 245 formed on the rear face 244 may comprise a truncated cylindrical wall extending across the entire height of the door body 230 to allow clearance for the actuation rod 236.

The slit valve door 228 is made up entirely of Al₂O₃ ceramic material that may have a bulk density of greater than 3.9×10³ kg/m³. The high bulk density provides for an Al₂O₃ ceramic material that is substantially free of surface pores. Substantially free of surface pores means that the porosity of the Al₂O₃ material is less than about 1%, or even less than about 0.5%. The Al₂O₃ ceramic material is able to be used in both oxidizing and reducing environments, can be used at temperatures of up to about 1925° C., and may resist attack by most gases. The surfaces of the slit valve door 228 may further be polished to obtain surface condition that is very smooth and easy to clean and is impervious. The Al₂O₃ ceramic material may be very strong and may have a bending strength of at least 480 Mpa at room temperature and a Young's modulus of at least 390 GPa. This high strength avoids bending and deflection of the slit valve door 228 along the lateral width of the slit valve door 228 that spans the width of the slit opening 223. Nihonceratec AHPF/AJPF material from Ceratec, Inc. of Santa Clara, Calif. may be used, for example. Other suitable Al₂O₃ materials may be used.

As shown in FIGS. 3B and 3C, the backing plate 226 supports the rear face 244 of the door body 230 and extends within about 10 mm or closer (e.g., 0 mm-10 mm) to a first side edge 350, a second side edge 352, a top edge 354, and a bottom edge 356 of the door body 230 such that the slit valve door 228 is substantially fully supported by the backing plate 226. Substantially supported means that at least 50% of the area of the rear face 244 is supported by the backing plate 226, including at least 60%, at least 70%, at least 80%, at least 90%, and even at least 95% in some embodiments. As shown in FIG. 3B, the backing plate 226 may include a tapering thickness from a central portion 358 to the first side edge 350 and a second side edge 352 on at least a portion thereof. In the depicted embodiment, the actuation rod 236 may be coupled to the central portion 358 of the backing plate 226. Weight reducing pockets 362 may be provided on the open face of the backing plate 226.

In the depicted embodiment, the rear face 244 of the door body 230 of the slit valve door 228 may be bonded to the supporting surface 364 of the backing plate 226. The bond may be formed by a thin layer of a bonding material 360 that may adhesively bond the door body 230 to the backing plate 226. The bonding material 360 may be any suitable material for bonding ceramics, such as an aluminum oxide filled or silicon-based bonding material, for example. The silicon-based material may be applied as liquid silicon with primer or as a sheet of silicon with primer. The bond layer may be between about 0.25 mm and 0.38 mm thick, for example. Other thicknesses may be used. Other means for attaching the door body 230 to the backing plate 226 may be used, such as bolting or clamping, or the like.

The foregoing description discloses only example embodiments of the invention. Modifications of the above-disclosed apparatus which fall within the scope of the invention will be readily apparent to those of ordinary skill in the art. Accordingly, while the present invention has been disclosed in connection with example embodiments thereof, it should be understood that other embodiments may fall within the scope of the invention, as defined by the following claims.

The invention claimed is:

1. A slit valve door, comprising:
a door body made entirely of a Al₂O₃ ceramic material, and
a seal coupled to the door body.

2. The slit valve door of claim 1, comprising an O-ring groove formed into a front face of the door body.

3. The slit valve door of claim 2, comprising an O-ring received in the O-ring groove.

4. The slit valve door of claim 1, wherein the door body includes a planar front face and a planar rear face and a recess formed on the planar rear face.

5. The slit valve door of claim 4, wherein the recess formed on the planar rear face comprises a truncated cylindrical wall.

6. The slit valve door of claim 1, wherein the Al₂O₃ ceramic material has a bulk density of greater than 3.9×10³ kg/m³.

7. The slit valve door of claim 1, wherein the Al₂O₃ ceramic material is substantially free of surface pores.

8. The slit valve door of claim 1, wherein the Al₂O₃ ceramic material has a bending strength of at least 480 Mpa at room temperature.

9. The slit valve door of claim 1, wherein the Al₂O₃ ceramic material has a Young's modulus of at least 390 GPa.

10. The slit valve door of claim 1, wherein the Al₂O₃ ceramic material comprises:
a Young's modulus of at least 390 GPa,
a bending strength of at least 480 Mpa at room temperature, and
a bulk density of greater than 3.9×10³ kg/m³.

11. A slit valve door assembly, comprising:
a backing plate; and
a slit valve door coupled to the backing plate, the slit valve door including:
a door body made entirely of a Al₂O₃ ceramic material, and
a seal coupled to the door body.

12. The slit valve door assembly of claim 11 wherein the backing plate comprises an aluminum material.

13. The slit valve door assembly of claim 11 wherein the backing plate supports a rear face of the door body and extends within 10 mm of a first side edge, a second side edge, and top edge, and bottom edge of the door body.

14. The slit valve door assembly of claim 11 wherein the backing plate includes a tapering thickness from a central portion to a first side edge and a second side edge.

15. The slit valve door assembly of claim 14 comprising an actuation rod coupled to the central portion of the backing plate.

16. The slit valve door assembly of claim 11 wherein the door body is bonded to the backing plate.

17. The slit valve door assembly of claim 16 comprising a layer of silicon-based material bonding the door body to the backing plate.

18. The slit valve door assembly of claim 11 wherein the Al₂O₃ ceramic material comprises:
a Young's modulus of at least 390 GPa,
a bending strength of at least 480 Mpa at room temperature, and
a bulk density of greater than 3.9×10³ kg/m³.

19. The slit valve door assembly of claim 11 wherein the door body is substantially free of pores.

20. A slit valve assembly, comprising:
a sealing insert including a slit opening and a sealing surface; and
a slit valve door assembly configured to seal against the sealing surface, the slit valve door assembly including:
a backing plate, and
a slit valve door coupled to the backing plate, the slit valve door including:
a door body made entirely of a Al₂O₃ ceramic material, and
a seal coupled to the door body.
